(19) United States
(12) Patent Application Publication
(10) Pub. No.: US 2025/0239855 A1
(43) Pub. Date: Jul. 24, 2025

(54) ROAMING CREDIT SYSTEM FOR EFFICIENT AND COMPLIANT RENEWABLE ENERGY POWERED CHARGING STATION

(71) Applicant: GM GLOBAL TECHNOLOGY OPERATIONS LLC, DETROIT, MI (US)

(72) Inventors: Arman Goudarzi, Surrey (CA); Alaa M. Khamis, Courtice (CA); Jarvis Chau, Markham (CA)

(21) Appl. No.: 18/417,176

(22) Filed: Jan. 19, 2024

(51) Int. Cl. H02J 3/32; B60L 53/62; B60L 58/12; G06Q 40/04; G06Q 50/06; H02J 3/00; H02J 3/38

(52) U.S. Cl. CPC H02J 3/32; B60L 53/62; B60L 58/12; G06Q 40/04; G06Q 50/06; H02J 3/003; H02J 3/004; H02J 3/38; H02J 2300/24; H02J 2300/28

(57) ABSTRACT

Embodiments include an electric vehicle charging station having a bi-directional charger electrically coupled to an electric grid and to one or more renewable energy sources, an energy storage device electrically connected to the bi-directional charger, and a processing system configured to control an operation of the bi-directional charger. The processing system is configured to monitor a state-of-charge of the energy storage device, calculate an estimated power demand on the electric vehicle charging station for a time period, calculate an estimated power generation of the one or more renewable energy sources during the time period, and responsively control the bi-directional charger.

### INTRODUCTION

The disclosure relates to charging stations. More specifically, the disclosure relates to charging stations that are at least partially powered by renewable energy sources (wind, solar, and battery energy storage systems (BESS)).

As the electric vehicle (EV) infrastructure continues to advance, particularly in the varied regions of North America (USA and Canada), the effective harnessing of renewable energy sources (RESs) at EV charging stations has become increasingly important. Renewable energy sources bolster the eco-friendliness of the charging stations and also reduces reliance on power generation from the electric grid. The strategic implementation and management of renewable energy sources gains significance as the usage of charging stations and the integration of renewable energy differ noticeably from one station to another.

Often, charging stations are part of a charging station network that includes multiple charging stations that are operated by a single entity. In a charging station network, some charging stations while having abundant opportunities for generating power from renewable energies, face limited usage (low utilization rates). In contrast, others with high utilization rates may lack significant renewable energy production.

### SUMMARY

In one exemplary embodiment, an electric vehicle charging station is provided. The electric vehicle charging station includes a bi-directional charger electrically coupled to an electric grid and to one or more renewable energy sources, an energy storage device electrically connected to the bi-directional charger, and a processing system configured to control an operation of the bi-directional charger. The processing system is configured to monitor a state-of-charge of the energy storage device, calculate an estimated power demand on the electric vehicle charging station for a time period, and calculate an estimated power generation of the one or more renewable energy sources during the time period. Based on a determination that the estimated power generation of the one or more renewable energy sources during the time period is greater than the estimated power demand during the time period and that the state-of-charge of the energy storage device is less than a maximum state-of-charge, the processing system is configured to instruct the bi-directional charger to charge the energy storage device. Based on a determination that the estimated power generation of the one or more renewable energy sources during the time period is greater than the estimated power demand during the time period and that the state-of-charge of the energy storage device is equal to the maximum state-of-charge, the processing system is configured to instruct the bi-directional charger to transmit power generated by the one or more renewable energy sources to the electric grid.

In addition to the one or more features described herein the processing system is further configured to update a renewable energy credit balance based on an amount of power generated by the one or more renewable energy sources to the electric grid that is transmitted to the electric grid.

In addition to the one or more features described herein the processing system is further configured to instruct the bi-directional charger to discharge the energy storage device to meet the estimated power demand, based on a determination that the estimated power generation of the one or more renewable energy sources during the time period is less than the estimated power demand during the time period and that the state-of-charge of the energy storage device is greater than a minimum state-of-charge.

In addition to the one or more features described herein the processing system is further configured to instruct the bi-directional charger to obtain power from the electric grid to meet the estimated power demand, based on a determination that the estimated power generation of the one or more renewable energy sources during the time period is less than the estimated power demand during the time period and that the state-of-charge of the energy storage device is equal to a minimum state-of-charge.

In addition to the one or more features described herein the processing system is further configured to update a renewable energy credit balance based on an amount of power obtained from the electric grid.

In addition to the one or more features described herein the processing system is further configured to monitor and record a percentage of power provided by the electric vehicle charging station to one or more vehicles during the time period that was obtained from the one or more renewable energy sources.

In addition to the one or more features described herein the estimated power demand on the electric vehicle charging station for a time period is calculated based on an analysis of historical power demand on the electric vehicle charging station.

In addition to the one or more features described herein the estimated power generation of the one or more renewable energy sources during the time period is calculated based on an analysis of historical power generation of the one or more renewable energy sources, corresponding historical weather conditions, and a weather forecast for the time period.

In addition to the one or more features described herein the electric vehicle charging station is a first electric vehicle charging station of a plurality of electric vehicle charging stations in a charging station network.

In one exemplary embodiment, an electric vehicle charging network is provided. The electric vehicle charging network includes having a charging station network management system and a plurality of electric vehicle charging stations in communication with the charging station network management system. Each of the plurality of electric vehicle charging stations include a bi-directional charger electrically coupled to an electric grid and to one or more renewable energy sources. an energy storage device electrically connected to the bi-directional charger, and a processing system configured to control the operation of the bi-directional charger. The processing system is configured to monitor a state-of-charge of the energy storage device, calculate an estimated power demand on the electric vehicle charging station for a time period, and calculate an estimated power generation of the one or more renewable energy sources during the time period. Based on a determination that the estimated power generation of the one or more renewable energy sources during the time period is greater than the estimated power demand during the time period and that the state-of-charge of the energy storage device is less than a maximum state-of-charge, the processing system is configured to instruct the bi-directional charger to charge the energy storage device. Based on a determination that the estimated power generation of the one or more renewable energy sources during the time period is greater than the estimated power demand during the time period and that the state-of-charge of the energy storage device is equal to the maximum state-of-charge, the processing system is configured to instruct the bi-directional charger to transmit power generated by the one or more renewable energy sources to the electric grid.

In addition to the one or more features described herein the processing system is further configured to transmit a renewable energy credit to the charging station network management system, wherein a value of the renewable energy credit is based on an amount of power generated by the one or more renewable energy sources to the electric grid that is transmitted to the electric grid.

In addition to the one or more features described herein the processing system is further configured to instruct the bi-directional charger to discharge the energy storage device to meet the estimated power demand, based on a determination that the estimated power generation of the one or more renewable energy sources during the time period is less than the estimated power demand during the time period and that the state-of-charge of the energy storage device is greater than a minimum state-of-charge.

In addition to the one or more features described herein the processing system is further configured to instruct the bi-directional charger to obtain power from the electric grid to meet the estimated power demand, based on a determination that the estimated power generation of the one or more renewable energy sources during the time period is less than the estimated power demand during the time period and that the state-of-charge of the energy storage device is equal to a minimum state-of-charge.

In addition to the one or more features described herein the processing system is further configured to obtain a renewable energy credit from the charging station network management system, wherein a value of the renewable energy credit is based on an amount of power obtained from the electric grid.

In addition to the one or more features described herein the processing system of an electric vehicle charging station is further configured to monitor and record a percentage of power provided by the electric vehicle charging station to one or more vehicles during the time period that was obtained from the one or more renewable energy sources.

In addition to the one or more features described herein the charging station network management system is configured to monitor and record a percentage of power provided by the plurality of electric vehicle charging stations to one or more vehicles during the time period that was obtained from the one or more renewable energy sources.

In addition to the one or more features described herein the estimated power demand on the electric vehicle charging station for a time period is calculated based on an analysis of historical power demand on the electric vehicle charging station.

In addition to the one or more features described herein the estimated power generation of the one or more renewable energy sources during the time period is calculated based on an analysis of historical power generation of the one or more renewable energy sources, corresponding historical weather conditions, and a weather forecast for the time period.

In addition to the one or more features described herein the charging station network management system is configured to control one or more operational characteristics of the plurality of electric vehicle charging stations based on a contextual multi-armed bandit analysis of shared contextual data for the plurality of electric vehicle charging stations, wherein the shared contextual data includes power generation predictions and power demand predictions.

In one exemplary embodiment, the method for operating a charging station is provided. The method includes monitoring a state-of-charge of an energy storage device of the charging station, calculating an estimated power demand on the charging station for a time period, and calculating an estimated power generation of one or more renewable energy sources during the time period. Based on a determination that the estimated power generation of the one or more renewable energy sources during the time period is greater than the estimated power demand during the time period and that the state-of-charge of the energy storage device is less than a maximum state-of-charge, the method includes charging the energy storage device with power generated by the one or more renewable energy sources. Based on a determination that the estimated power generation of the one or more renewable energy sources during the time period is greater than the estimated power demand during the time period and that the state-of-charge of the energy storage device is equal to the maximum state-of-charge, the method includes transmitting power generated by the one or more renewable energy sources to an electric grid. Based on a determination that the estimated power generation of the one or more renewable energy sources during the time period is less than the estimated power demand during the time period and that the state-of-charge of the energy storage device is equal to a minimum state-of-charge, the method includes obtaining power from the electric grid to meet the estimated power demand.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a block diagram of a system including a charging station powered by renewable energy sources in accordance with an exemplary embodiment;

FIG. 2 is a flowchart diagram illustrating a method for operating a charging station powered by renewable energy sources in accordance with an exemplary embodiment;

FIG. 3 is a flowchart diagram illustrating another method for operating a charging station powered by renewable energy sources in accordance with an exemplary embodiment;

FIG. 4 is a flowchart diagram illustrating a further method for operating a charging station powered by renewable energy sources in accordance with an exemplary embodiment;

FIG. 5 is a flowchart diagram illustrating a contextual multi-armed bandit method for determining optimal operational characteristics of charging stations operated by a charging station operator in accordance with an exemplary embodiment; and

FIG. 6 is a block diagram of a system including a charging station powered by renewable energy sources in accordance with an exemplary embodiment.

### DETAILED DESCRIPTION

The following description is merely exemplary in nature and is not intended to limit the present disclosure, its application, or its uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

As discussed herein, a charging station that is configured to receive power from renewable energy sources and from an electric grid is provided. In exemplary embodiments, the charging station includes a bi-directional charger that is electrically coupled to an electric grid and to one or more renewable energy sources. One or more renewable energy sources may include a solar energy source, a wind energy source, or the like. The charging station also includes an energy storage device, such as a battery pack, that is electrically connected to the bi-directional charger. The charging station further includes a processing system that is configured to control the operation of the bi-directional charger.

In exemplary embodiments, the processing system is configured to monitor a state-of-charge of the energy storage device, calculate an estimated power demand on the charging station for a time period, and calculate an estimated power generation of one or more renewable energy sources during the time period. Based on the state-of-charge of the energy storage device, the estimated power demand on the charging station, and the estimated power generation of the one or more renewable energy sources during the time period, the processing system responsively instructs the bi-directional charger to charge or discharge the energy storage device to maximize the utilization of the energy created by the one or more renewable energy sources while meeting the power demand on the charging station.

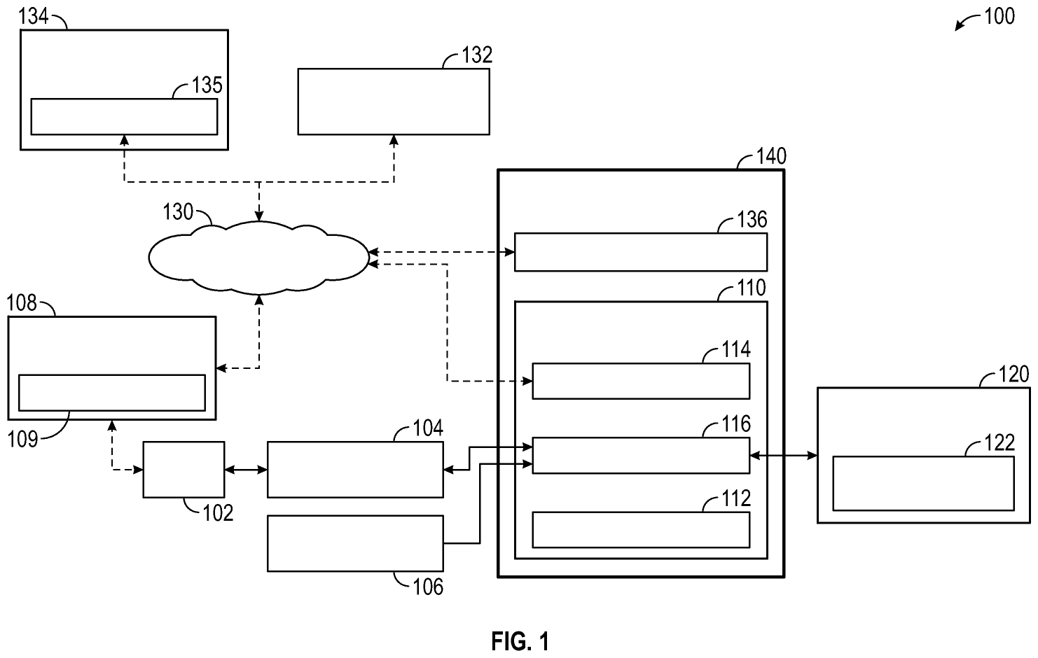

Referring now to FIG. 1, a block diagram of a system 100 including a charging station 110 powered by renewable energy sources 106 in accordance with an exemplary embodiment is shown. The charging station 110 includes an energy storage device 112, a processing system 114, and a bi-directional charger 116. In exemplary embodiments, the processing system 114 includes one or more processors and memory that includes computer program instructions configured to control the operation of the charging station 110. In exemplary embodiments, the charging station 110 is configured to charge an energy storage device 122 of an electric vehicle 120 that is removably connected to the charging station 110.

In exemplary embodiments, the charging station 110 is electrically connected to an electric grid 102 via a transmission network 104. The electric grid 102 is operated by processing systems 109 of one or more electricity market operators 108. In exemplary embodiments, the processing systems 109 of one or more electricity market operators 108 and the processing system 114 of the charging station 110 are in communication with a communications network 130, such as the Internet. In exemplary embodiments, the processing system 109 includes one or more processors and memory that includes computer program instructions configured to control the operation of the electric grid 102 under the control of the electricity market operator 108. The system 100 may also include one or more of a processing system 135 of a regulatory or state agency 134, a weather forecasting system 132, and a processing system 136 of the charging station network 140, which may be in communication with the communications network 130.

In exemplary embodiments, the charging stations 110 are part of a charging station network 140 that includes a plurality of charging stations 110 that are commonly owned and operated. In one embodiment, the processing systems of each of the plurality of charging stations 110 are configured to communicate with a processing system 136 of the charging station network 140, which coordinates the control and operation of each of the plurality of charging stations 110. In exemplary embodiments, the processing system 136 includes one or more processors and memory that include computer program instructions configured to control the operation of the charging station network 140.

In exemplary embodiments, the processing system 114 is configured to monitor a state-of-charge of the energy storage device 112, calculate an estimated power demand on the charging station 110 during a time period, and calculate an estimated power generation of the one or more renewable energy sources 106 during the time period.

In one embodiment, the estimated power demand on the electric vehicle charging station for a time period is calculated based on an analysis of historical power demand on the electric vehicle charging station. For example, an estimated power demand for a charging station can be estimated based on historical power consumption by the processing system 114. The processing system 114 may collect historical power consumption data from the charging station. This data should include timestamps, power consumption values, and any relevant contextual information (e.g., time of day, day of the week, weather conditions). Next, the processing system 114 may clean and preprocess the collected data to handle missing values, outliers, and inconsistencies. The preprocessing can also include converting timestamps to a consistent format and extracting relevant features such as time of day, day of the week, and holidays. The processing system 114 may create additional features that may influence power demand, such as special events, promotions, or any external factors affecting usage patterns. Once the data has been preprocessed, the processing system 114 splits the dataset into training and testing sets. The training set is used to train a predictive model, while the testing set is used to evaluate its performance. In exemplary embodiments, various predicted models, such as Autoregressive Integrated Moving Average (ARIMA), Long Short-Term Memory (LSTM) neural networks, Gradient Boosted Trees (e.g., XGBoost), and Support Vector Machines (SVM) can be evaluated. Once a predicted model is selected and trained, the trained model is deployed to generate real-time power demand predictions based on the latest data.

In one embodiment, the estimated power generation of the one or more renewable energy sources during the time period is calculated based on an analysis of the historical power generation of the one or more renewable energy sources, corresponding historical weather conditions, and a weather forecast for the time period. In an exemplary embodiment, the processing system 114 may collect historical power generation data from the charging station and historical weather data. This data should include timestamps, power consumption values, and any relevant contextual information (e.g., time of day, day of the week). Next, the processing system 114 may clean and preprocess the collected data to handle missing values, outliers, and inconsistencies. Once the data has been preprocessed, the processing system 114 splits the dataset into training and testing sets. The training set is used to train a predictive model, while the testing set is used to evaluate its performance. In exemplary embodiments, various predicted models, such as Autoregressive Integrated Moving Average (ARIMA), Long Short-Term Memory (LSTM) neural networks, Gradient Boosted Trees (e.g., XGBoost), and Support Vector Machines (SVM) can be evaluated. Once a predicted model is selected and trained, the trained model is deployed to generate predictions for the power generation of the one or more renewable energy sources based on the latest data.

In exemplary embodiments, the charging station network 140 includes charging stations that are disposed in a geographic area, which includes a plurality of electricity market operators 108 that provide power to an electric grid 102. In exemplary embodiments, a charging station operator manages a plurality of the charging stations 110, which may be dispersed across the geographic area in regions that are managed by different electricity market operators 108.

In exemplary embodiments, the electricity market operator 108 is configured to communicate with one or more of a regulatory agency that regulates the operation of the electric grid 102. In one embodiment, the regulatory agency 134 may require that charging station operators within the geographic area obtain a minimum percentage of power that is sold by their charging stations from renewable energy sources. In one embodiment, the processing systems 109 of the electricity market operators 108 monitor the compliance of the charging station operators with the regulations provided by the regulatory agency 134.

In exemplary embodiments, a credit system is used to address an imbalance between renewable energy production and power demand by different charging stations 110 of a charging station network 140 that are serviced by different electricity market operators 108. By promoting more effective energy utilization and enabling the exchange of renewable energy credits (RECs) among charging stations 110 within a charging station network 140, the utilization of renewable resource usage and compliance with current renewable portfolio standards (RPSs) can be improved.

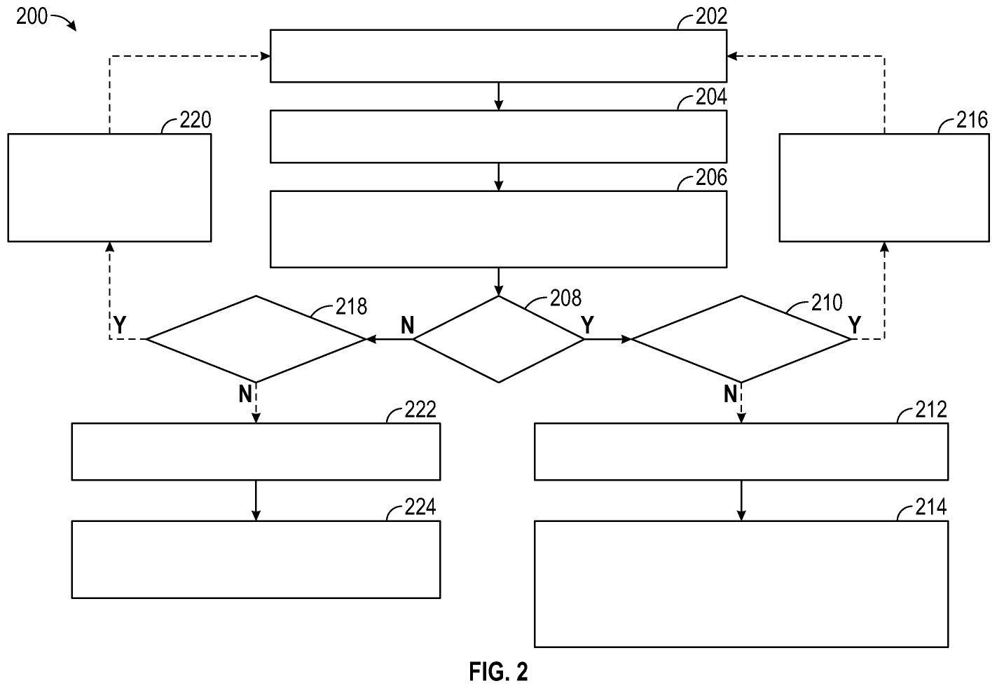

Referring now to FIG. 2, a flowchart diagram illustrating a method 200 for operating a charging station powered by renewable energy sources in accordance with an exemplary embodiment is shown. In exemplary embodiments, the method 200 is performed by the processing system 114 of the charging station 110, as shown in FIG. 1. At block 202, the method 200 includes monitoring a state-of-charge (SOC) of the energy storage device of a charging station. Next, at block 204, the method 200 includes calculating an estimated power demand (P_{D}) on the electric vehicle charging station for a time period. At block 206, the method 200 includes calculating an estimated power generation (P_{G}) of the one or more renewable energy sources during the time period.

At decision block 208, the method 200 includes determining whether P_{G} is greater than P_{D}. If P_{G} is greater than P_{D} the method 200 proceeds to decision block 210 and determines if the SOC of the energy storage device is less than a maximum SOC. Based on a determination that P_{G}is not greater than P_{D} the method 200 proceeds to decision block 218 and determines whether the SOC of the energy storage device is greater than a minimum SOC. Based on a determination that the SOC of the energy storage device is less than a maximum SOC, the method 200 proceeds to block 216, and the energy storage device is charged using the one or more renewable energy sources. Based on a determination that the SOC of the energy storage device is not less than a maximum SOC, the method 200 proceeds to block 212, and power generated by the one or more renewable energy sources is transmitted to the electric grid. At block 214, the method 200 includes increasing a renewable energy credit balance based on the amount of power generated by the one or more renewable energy sources that is transmitted to the electric grid.

Based on a determination that the SOC of the energy storage device is greater than a minimum SOC, the method 200 proceeds to block 220, and the energy storage device is discharged to meet the estimated power demand. Based on a determination that the SOC of the energy storage device is not greater than a minimum SOC, the method 200 proceeds to block 222, and power from the electric grid is obtained to meet the estimated power demand. The obtained power may be stored in the energy storage device and/or be provided directly to an electric vehicle connected to the charging station. At block 224, the method 200 includes decreasing a renewable energy credit balance based on the amount of power obtained from the electric grid.

As used herein. P_{RES}^{t} is the total power output of renewable energy sources at each charging station of a charging station network at time t, P_{WT}^{t} is the power output of wind turbines at time t, and P_{PV}^{t}, is the power output of solar panels at t, wherein P_{RES}^{t}=P_{WT}^{t}+_{PV}^{t}. In exemplary embodiments, the state-of-charge (SOC) of the battery of a charging station at time t can be represented as

$${SOC}_{Batt}^{t} = {SOC}_{Batt}^{t - 1} + \frac{{η}_{ch} {P}_{ch}^{t} Δ t}{{B}_{cap}} + \frac{1}{{η}_{Dch} {B}_{cap}} {P}_{Dch}^{t} Δ t ,$$

where the SOC is subject to the following constraints:

$${SOC}_{Batt}^{min} \leq {SOC}_{Batt}^{t} \leq {SOC}_{Batt}^{max} ;$$

$${P}_{ch}^{min} \leq {P}_{ch}^{t} \leq {P}_{ch}^{max} ;$$

$${P}_{Dch}^{min} \leq {P}_{Dch}^{t} \leq {P}_{Dch}^{max} ;$$

$${P}_{ch}^{t} = min \{ ( {P}_{RES}^{t} - {P}_{load}^{t} ) , ( \frac{( {SOC}_{Batt}^{max} - {SOC}_{Batt}^{t} ) {B}_{cap}}{{η}_{ch}} \} ;$$

$${P}_{Dch}^{t} = min \{ ( {P}_{load}^{t} - {P}_{RES}^{t} ) , ( ( {SOC}_{Batt}^{t} - {SOC}_{Batt}^{min} ) {η}_{Dch} {B}_{cap} ) \} ;$$

where SOC_{Batt}^{t} is the state of charge of the battery that is connected to the charging station at time t, SOC_{Batt}^{max} and SOC_{Batt}^{min} are the maximum and minimum state of the charge of a battery that is connected to a charging station, P_{ch}^{t} and P_{Dch}^{t} are the amount of charge and discharge power that a battery receives and gives at time t, P_{ch}^{min} and P_{ch}^{max} are the minimum and maximum amount of charge power that a battery receives, P_{Dch}^{min} and P_{Dch}^{max} are the minimum and maximum amount of discharge power that a battery gives, η_{ch} and η_{Dch} are the charging and discharging efficiency of a battery, B_{cap}: is the battery capacity, and Δt is the time slot or the time period.

An additional constraint is that P_{credit}^{min}≤P_{credit}^{t}≤P_{credit}^{max}, where P_{credit}^{t} is the amount of the power credit that has been produced to be exchanged at time t, P_{credit}^{min} is the minimum credit that each charging station operator (CSO) can have, and P_{credit}^{max} it is the maximum credit that each CSO can have. In exemplary embodiments, P_{credit}^{t} will include the following the time of the transaction, the rate of electrical power from the grid at the time of the transaction, the location of the transaction, and an identification of the grid operator or the utility name that power was purchased from or sold to.

A further constraint is that 0≤P_{load}^{t}≤P_{load}^{max}, where P_{load}^{t} is the amount of charge that each CS needs to provide to EVs at each hour of operation, and P_{load}^{max} is the total amount of charge that each CS can provide to its customers. In exemplary embodiments, P_{CS2G}^{t} is the amount of power that a charging station is transferring (crediting or selling) to the electric grid at time t and P_{G2CS}^{t} is the amount of power that the electric grid is transferring (crediting or selling) to the charging station.

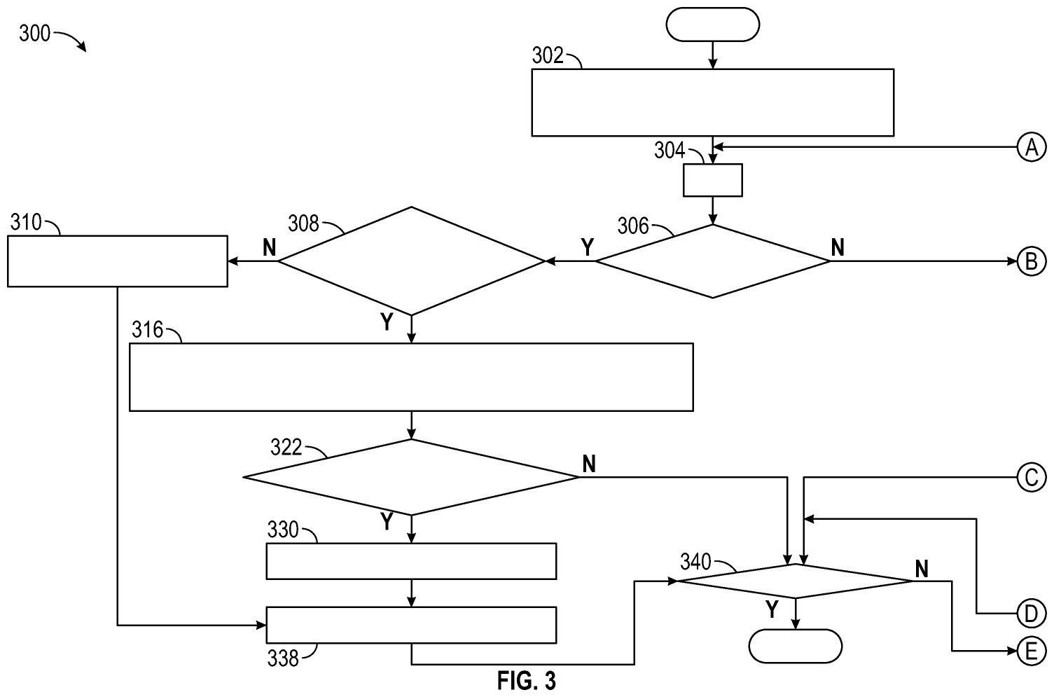

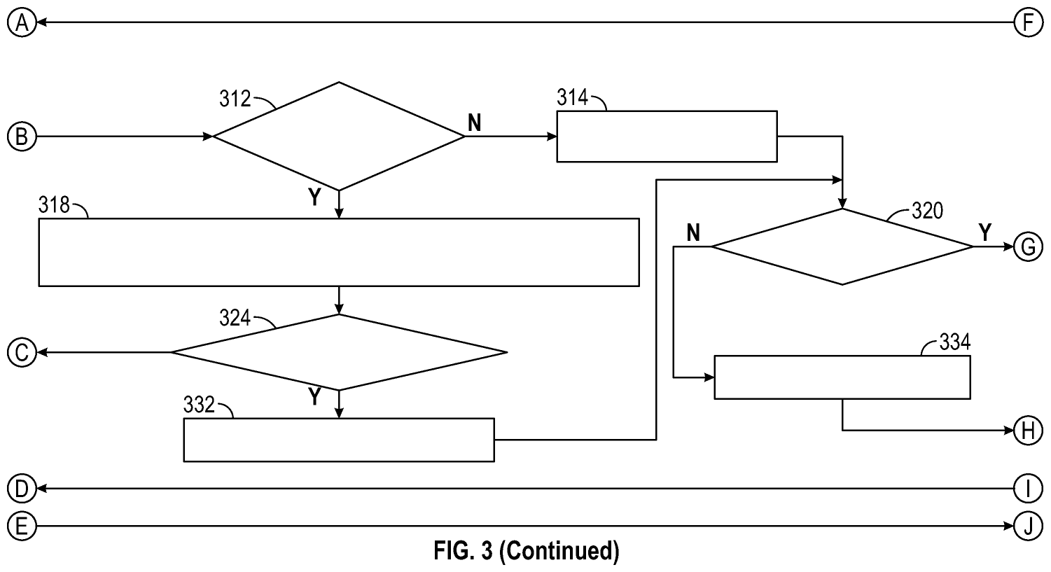

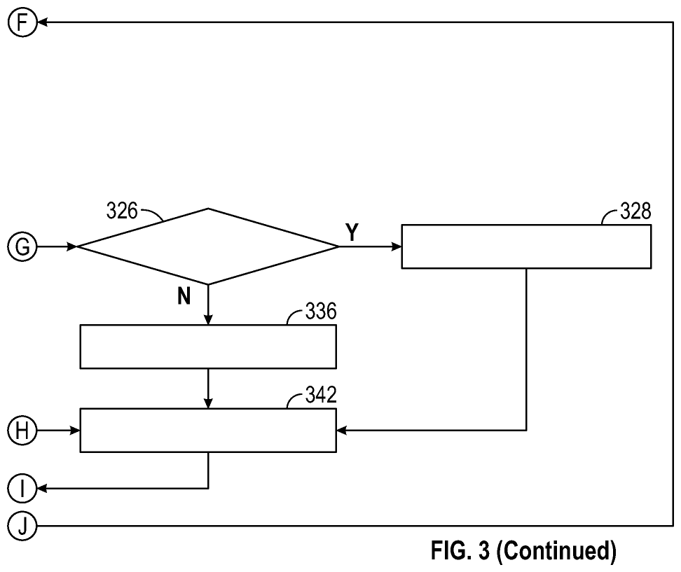

Referring now to FIG. 3, a flowchart diagram illustrating another method 300 for operating a charging station powered by renewable energy sources in accordance with an exemplary embodiment is shown. In exemplary embodiments, the method 300 is performed by the processing system 114 of the charging station 110, as shown in FIG. 1. As shown at block 302, the method 300 includes obtaining P_{RES}^{t}, P_{toad}^{t}, SOC_{Batt}^{t}, and P_{credit}^{t}. Next, at block 304, the value for the time period t is set to one. At decision block 306, the method 300 includes determining whether P_{load}^{t}≤P_{RES}^{t}. Based on a determination that P_{load}^{t}≤P_{RES}^{t}, the method 300 proceeds to decision block 312, and otherwise the method 300 proceeds to decision block 308. At decision block 308, the method 300 includes determining whether SOC_{Batt}^{t}<SOC_{Batt}^{t}>SOC_{Batt}^{min}. Based on a determination that SOC_{Batt}^{t}<SOC_{Batt}^{min}, the method 300 proceeds to block 316, and otherwise the method 300 proceeds to block 310. At decision block 312, the method 300 includes determining whether SOC_{Batt}^{t}>SOC_{Batt}^{min}. Based on a determination that SOC_{Batt}^{t}>SOC_{Batt}^{min}, the method 300 proceeds to block 314, and otherwise the method 300 proceeds to block 318.

Continuing with reference to FIG. 3, at block 310, the method 300 includes setting P_{G2CS}^{t} to equal P_{RES}^{t}−P_{load}^{t}. At block 314, the method 300 includes setting P_{G2CS}^{t} to equal P_{load}^{t}−P_{RES}^{t}. At block 316, the method 300 includes setting

$${P}_{ch}^{t} to equal min \{ ( {P}_{RES}^{t} - {P}_{l o a d}^{t} ) , ( \frac{( {SOC}_{Batt}^{max} - {SOC}_{Batt}^{t} ) {B}_{cap}}{{η}_{ch}} \} .$$

At block 318, the method 300 includes setting P_{Dch}^{t} to equal min{(P_{load}^{t}−P_{RES}^{t}), ((SOC_{Batt}^{t}−SOC_{Batt}^{min})η_{Dch}B_{cap})}. At decision block 320, the method 300 includes determining whether P_{credit}^{t}≤P_{G2CS}^{t}. Based on a determination that P_{credit}^{t}≤P_{G2CS}^{t}, the method 300 proceeds to block 326, and otherwise the method 300 proceeds to block 334.

At decision block 322, the method 300 includes determining whether P_{RES}^{t}>P_{ch}^{t}+P_{load}^{t}. Based on a determination that P_{RES}^{t}>P_{ch}^{t}+P_{load}^{t}, the method 300 proceeds to block 330, and otherwise the method 300 proceeds to block 340. At decision block 324, the method 300 includes determining whether P_{RES}^{t}+P_{Dch}^{t}<P_{load}^{t}. Based on a determination that P_{RES}^{t}+P_{Dch}^{t}<P_{load}^{t}, the method 300 proceeds to block 332, and otherwise the method 300 proceeds to block 340. At decision block 326, the method 300 includes determining whether P_{credit}^{t}>0. Based on a determination that P_{credit}^{t}>0, the method 300 proceeds to block 328, and otherwise the method 300 proceeds to block 336.

At block 328, the method 300 includes setting P_{G2CS}^{t} to equal P_{G2GS}^{t}−P_{credit}^{t}. At block 330, the method 300 includes setting P_{CS2G}^{t} to equal P_{RES}^{t}−(P_{credit}^{t}+P_{ch}^{t}). At block 332, the method 300 includes setting P_{G2CS}^{t} to equal P_{load}^{t}−(P_{RES}^{t}+P_{Dch}^{t}). At block 334, the method 300 includes setting P_{credit}^{t} to equal P_{credit}^{t}−P_{CS2G}^{t}. At block 336, the method 300 includes setting P_{credit}^{t} to equal P_{credit}^{t}−P_{CS2G}^{t}. At block 338, the method 300 includes setting P_{credit}^{t} to equal P_{credit}^{t}+P_{G2CS}^{t}. At block 342, the method 300 includes updating the value of P_{credit}^{t}. At decision block 340, the method 300 determines whether t+1>H, wherein H is the end of the time period for prediction.

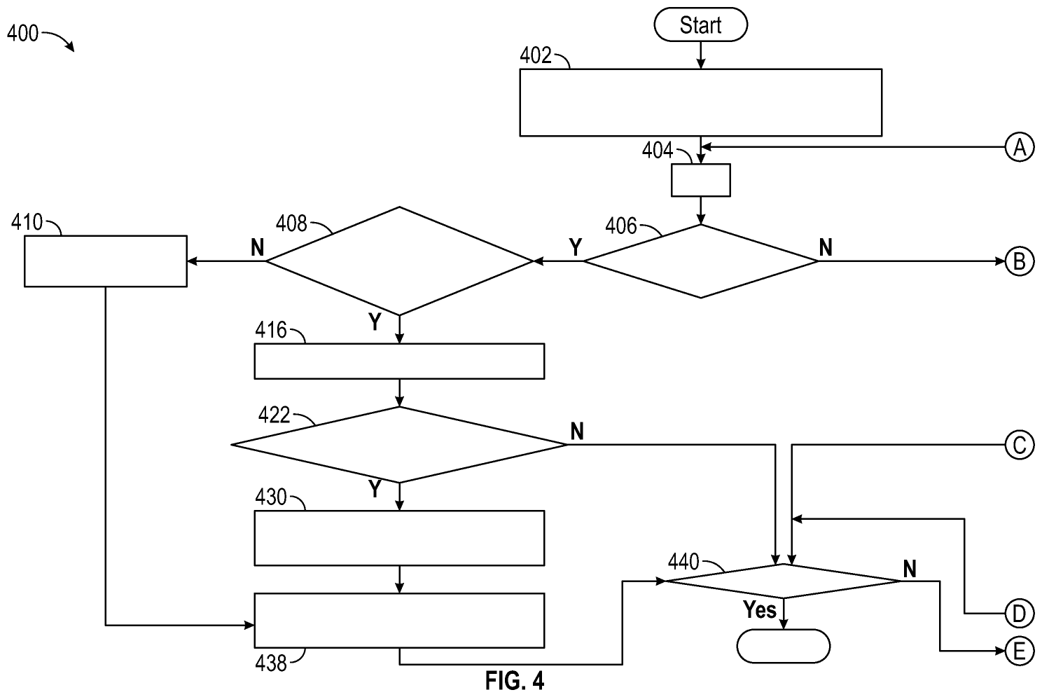

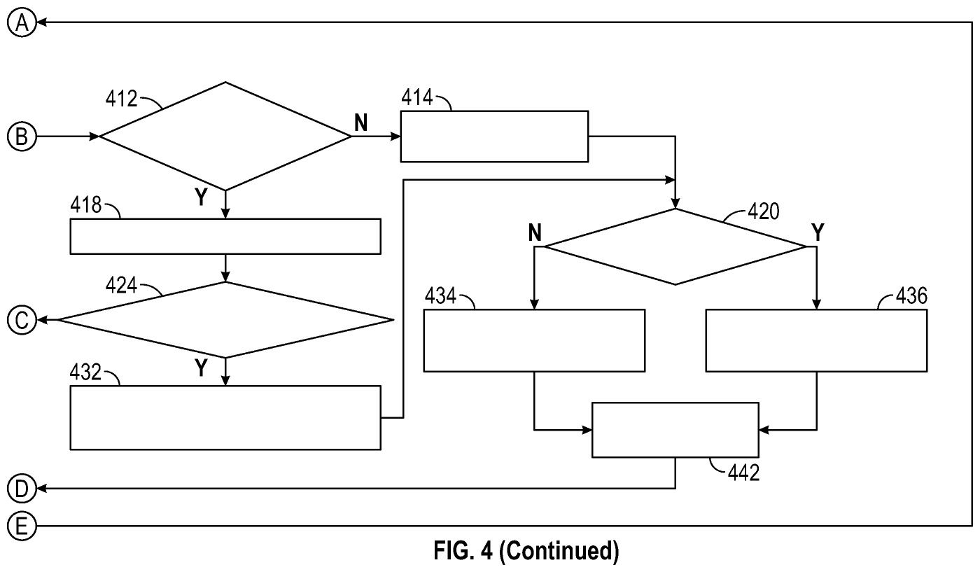

Referring now to FIG. 4, a flowchart diagram illustrating a method 400 for operating a charging station powered by renewable energy sources in accordance with an exemplary embodiment is shown. In exemplary embodiments, the method 400 is performed by the processing system 114 of the charging station 110, as shown in FIG. 1.

As shown at block 402, the method 400 includes obtaining P_{RES}^{t}, P_{load}^{t}, SOC_{Batt}^{t} and P_{credit}^{t}. Next, at block 404, the value for the time period t is set to one. At decision block 406, the method 400 includes determining whether P_{load}^{t}≤P_{RES}^{t}. Based on a determination that P_{load}^{t}≤P_{RES}^{t}, the method 400 proceeds to decision block 412, and otherwise the method 400 proceeds to decision block 408. At decision block 408, the method 400 includes determining whether SOC_{Batt}^{t}<SOC_{Batt}^{min}. Based on a determination that SOC_{Batt}^{t}<SOC_{Batt}^{max}, the method 400 proceeds to block 416, and otherwise the method 400 proceeds to block 410. At decision block 412, the method 400 includes determining whether SOC_{Batt}^{t}>SOC_{Batt}^{min}. Based on a determination that SOC_{Batt}>SOC_{Batt}^{min}, the method 400 proceeds to block 414, and otherwise the method 400 proceeds to block 418.

Continuing with reference to FIG. 4, at block 410, the method 400 includes selling power from the charging station to the electric grid. At block 414, the method 400 includes the charging station buying power from the electric grid. At block 416, the method 400 includes charging the battery of the charging station with power obtained from the renewable energy sources. At block 418, the method 400 includes discharging the battery of the charging station to meet the power demands of the charging station. At decision block 420, the method 400 includes determining whether P_{credit}^{t}≤P_{G2CS}^{t}. Based on a determination that P_{credit}^{t}≤P_{G2CS}^{t}, the method 400 proceeds to block 436, and otherwise the method 400 proceeds to block 434.

At decision block 422, the method 400 includes determining whether P_{RES}^{t}>P_{ch}^{t}+P_{load}^{t}. Based on a determination that P_{RES}^{t}>P_{ch}^{t}+P_{load}^{t}, the method 400 proceeds to block 430, and otherwise the method 400 proceeds to block 440. At decision block 424, the method 400 includes determining whether P_{RES}^{t}+P_{Dch}^{t}<P_{load}^{t}. Based on a determination that P_{RES}^{t}+P_{Dch}^{t}<P_{load}^{t}, the method 400 proceeds to block 432, and otherwise the method 400 proceeds to block 440.

At block 430, the method 400 includes selling power generated by the renewable energy sources to the electric grid after the battery of the charging station has been fully charged. At block 438, the method 400 includes increasing the renewable energy credit balance associated with the charging station based on the power sold to the electric grid. At block 432, the method 400 includes buying power from the electric grid after the battery of the charging station has been fully depleted. At block 434, the method 400 include reducing the renewable energy credit balance associated with the charging station based on the power bought from the electric grid. At block 436, the method 400 includes further reducing a negative the renewable energy credit balance associated with the charging station based on the power bought from the electric grid. At block 442, the method 400 includes updating a renewable energy credit value associated with the charging station and/or with a network of charging stations that include the charging station. At decision block 440, the method 400 determines whether t+1>H, wherein H is the end of the time period for prediction.

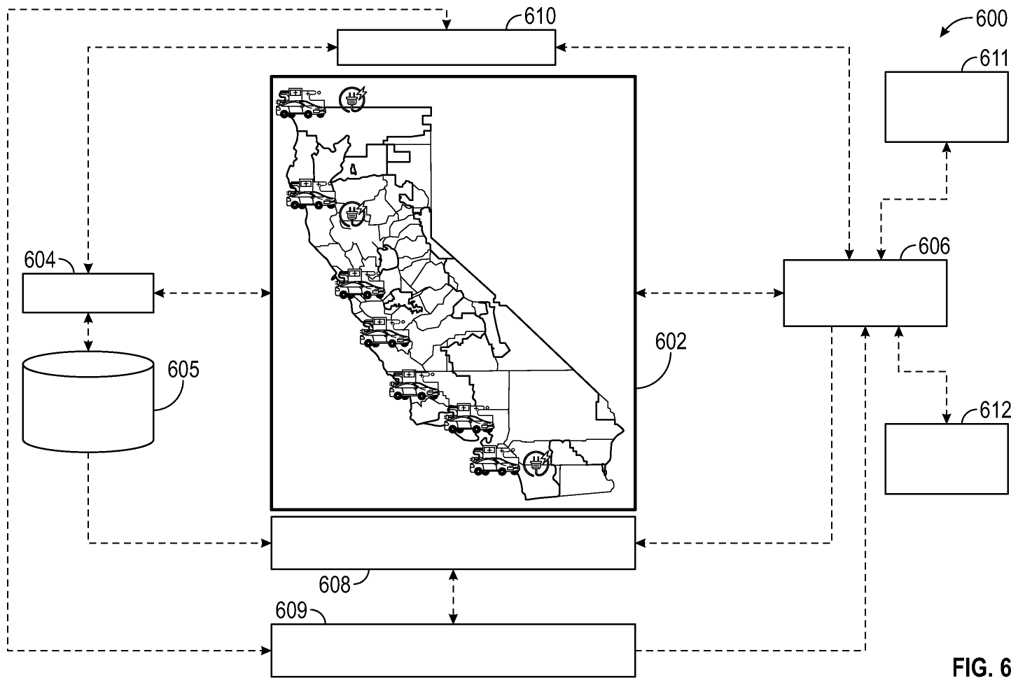

One example will now be discussed with reference to FIG. 6, which illustrates a system 600 including charging stations (CSs) powered by renewable energy sources in accordance with an exemplary embodiment. In one example, Company X is a charging station operator (SCO) 604 that operates a network of electric vehicle (EV) charging stations in various regions of geographic area 602, illustrated as the state of California. Each of the regions are managed by different electricity market operators 606. The electricity market operators 606 are configured to communicate with regulatory agencies 611 and state agencies 612 to ensure proper usage and compliance with regulations regarding the creation and use of renewable energy credits. The electricity market operators 606 are configured to provide the system operator 610 with their generation capacity, transmission status, regulatory info, energy pricing, unit capacity, power transactions, and the like. The electricity market operators 606 are configured to provide their market prices to the energy production and energy demand prediction models 608.

The charging station operator (CSO) 604 is configured to provide the system operation 610 with the Charging demand, CSs' and regulatory info, generation capacity, demand forecast, power transactions, and the like for each charging station (SC) of the charging station network. In exemplary embodiments, the energy production and energy demand prediction models 608 are configured to estimate the power generated by renewable energy sources associated with each charging station and to estimate the predicted power demand for each charging station. In exemplary embodiments, the energy production and energy demand prediction models 608 are created based at least in part of the contextual information 605. The system 600 also includes a roaming-credit computation unit 609 that is configured to calculate and maintain a renewable energy credit balance associated with each charging station operator 604.

The charging stations (CS), CS1 and CS2, both derive power partly from renewable energy sources (RES) such as wind, solar, and battery energy storage systems (BESS) that are located within the stations' facilities. In one embodiment, CS1 is located in Zone A, governed by Utility A, and CS2 is in Zone B, under the administration of Utility B. CS1 is provided with a considerable capacity for generating renewable energy but faces a challenge with a low utilization rate (UR), estimated to be under 2%. In contrast, CS2 has a more limited renewable energy production capability but benefits from a high utilization rate (UR), ranging between 15-20%. Both CS1 and CS2 are equipped with the facility to either sell or credit their excess renewable energy production back to their respective utility companies. In exemplary embodiments a system operator 610 is configured to enable CS1 and CS2 to transfer excess renewable energy to their respective utilities, allowing for credit claims either within their own zones or across zones. For example, CS1 can supply 5 kWh of energy to Utility A, and CS2, under Company X's ownership, can redeem an equivalent 5 kWh from Utility A or Utility B. This process is subject to Time of Use (ToU) rates and other relevant fees or charges.

In exemplary embodiments, Renewable Energy Certificates (RECs) produced by charging stations can be traded among utilities within a specific region or state/province. For instance, in California, all six major utilities—PacifiCorp, PG&E, Liberty Utilities, SCE, Bear Valley Electric Services, and SDG&E—have established an agreement to exchange the generated RECs among themselves. At the time of generating and trading Renewable Energy Certificates (RECs), specific rates and tariffs will be applied. For instance, a REC created during peak demand periods will hold a higher value, reflecting the time-of-use tariffs, real-time pricing, or locational marginal prices in effect at that time.

In exemplary embodiments, employing a renewable credit system as described offers several potential benefits for the charging station operators such as financial efficiency, transactional cost savings, enhanced regulatory compliance, and reduced environmental impact. In exemplary embodiments, the renewable credit system offers a distinct financial advantage for Company X, especially if the price for selling excess renewable energy in Zone A is lower than the cost of buying additional energy in either Zone A or Zone B. By utilizing the credit system, Company X can effectively: (i) ‘Virtually Store’ or ‘Systematically Store’ the surplus renewable energy, allowing it to reclaim this energy from Utility A as needed, thus circumventing the lower sale price. (ii) ‘Transfer’ excess energy from Zone A to Zone B, sidestepping the financial inefficiency of selling at a lower price and then buying at a higher price.

In exemplary embodiments, the renewable credit system may also lead to significant savings in transactional costs. This is particularly true when considering the Time of Use (ToU) rates and various associated fees. By crediting energy instead of engaging in the conventional sell-and-buy process, Company X can bypass the costs linked to these transactions. Additionally, the company could capitalize on the differences in energy rates between the two utilities, further enhancing its cost efficiency.

In exemplary embodiments, the renewable credit system enhances the ability of Company X to comply with existing renewable energy standards or mandates that may be in force in either Zone A, Zone B, or both. By utilizing credits in Zone A or transferring them from Zone A (characterized by excess renewable energy production) to Zone B (noted for high utilization but lower renewable production), Company X can effectively augment the share of its energy derived from renewable sources. This strategic approach enables the company to not only comply with regulatory mandates but also to demonstrate its commitment to sustainable energy practices.

In exemplary embodiments, the implementation of the renewable credit system by Company X maximizes the utilization of its renewable energy production, ensuring that energy is not wasted, regardless of its geographical consumption point. This approach significantly contributes to reducing the company's overall environmental footprint and bolsters renewable energy generation. The environmental benefits include ensuring the complete utilization of generated renewable power, which resonates with the broader objective of encouraging renewable energy usage and curtailing greenhouse gas emissions. Under the renewable credit system, Company X effectively generates its own Renewable Energy Certificates (RECs) at CS1, where renewable energy production is substantial. Rather than selling these RECs, Company X utilizes them to balance the energy consumption at CS2, which has a high demand but limited renewable energy generation. This represents a model of ‘internal’ or ‘self-supply’ REC trading, where a company uses the RECs generated at one site to compensate for energy use at another site within the same Zone. This method presents an efficient solution for companies with multiple facilities and diverse renewable energy production and consumption profiles to achieve their renewable energy targets.

In exemplary embodiments, the renewable credit system offers Company X enhanced adaptability in managing its energy consumption across various sites. This flexibility becomes particularly valuable when anticipating future shifts in the company's energy requirements. For instance, should the utilization at CS1 increase or the renewable energy production at CS2 improve, Company X can seamlessly modify the volume of credits transferred, both between and within the respective zones.

In exemplary embodiments, the renewable credit system promotes the usage of renewable energy. For example, through the crediting of its surplus renewable energy, Company X actively advocates for the adoption of green energy practices. This strategy not only contributes to a more sustainable energy landscape but also elevates the company's standing as a leader in environmental stewardship and sustainability.

Returning now to FIG. 6, in exemplary embodiments, system operator 610 is configured to control the exchange of renewable energy credits among charging stations of a charging station operator 604. In one embodiment, the system operator 610 of the charging station network is configured to ensure that the exchange of renewable energy credits among charging stations of a charging station operator 604 complies with one or more objective functions and operational constraints.

In one embodiment, an objective function of charging station operator 604 is the maximization of the profit of the charging station network, which can be represented as: max Σᵢ₌₁^{N}(α×ESGᵢ−β×EPGᵢ−OCᵢ), where ESGᵢ is the energy sold to the grid at charging station i, EPGᵢ is the energy purchased from the grid at charging station i, OCᵢ is the operation cost of charging station i, α is the price or cost coefficient of the energy sold to the grid, β is the price or cost coefficient of the energy purchased from the grid., and N is the number of charging stations (CSs) in the charging station network. In another embodiment, an objective function of the charging station network 140 is the minimization of the carbon emissions of the charging station network, which can be represented as: min Σᵢ₌₁^{N}(γ×EPGᵢ), where γ is the emission volume coefficient of the energy purchased from the grid.

In one embodiment, one operational constraint of the charging station operator 604 is an energy balance constraint, which can be represented as: EPGᵢ+REPᵢ=ECᵢ+ESGᵢ+Σⱼ₌₁^{N}, CTA_{i,j}−Σₖ₌₁^{N}CTA_{k,i}, where REPᵢ is the renewable energy produced at charging station i, ECᵢ is the energy consumed at charging station i for charging EVs, CTA_{i,j} is the credit transfer amounts from charging station i to charging station j, CTA_{k,i} is the credit transfer amounts from charging station k to charging station i, Σⱼ₌₁^{N}CTA_{i,j} is the total credit transferred from charging station i to all other charging stations, and Σₖ₌₁^{N}CTA_{k,i} is the total credit transfer received by charging station i from all other charging stations.

In one embodiment, another operational constraint of the charging station operator 604 is a transmission line capacity constraint, which can be represented as: TL_{i,j}^{min}≤CTA_{i,j}≤TL_{i,j}^{max}, where TL_{i,j}^{min}: the lower bound of the transmission line limit that connects station i to j and TL_{i,j}^{max}: the upper bound of the transmission line limit that connects station i to j. In one embodiment, a further operational constraint of the charging station network 140 is a regulatory compliance constraint, which can be represented as:RPSᵢ≤yᵢ+ΣCTA_{j,i}−Σ_{i≠j}^{N}CTA_{i,j}, where RPSᵢ is the minimum amount of renewable energy that charging station i is required to use or produce, as mandated by regulations, yᵢ is the amount of renewable energy generated at charging station i, Σ_{j≠i}^{N}CTA_{j,i} is the amount of renewable energy credits (RECs) transferred from station j to i, and E_{i≠j}^{N}CTA_{i,j} is the amount of renewable energy credits (RECs) transferred from station i to j.

In one embodiment, another operational constraint of the charging station operator 604 is a preferred credit transfer constraint, which can be represented as: λΣ_{i,j}, PCT_{i,j}×CTA_{i,j}, wherein λ is a weighting factor that balances the importance of profit maximization and preferred credit transfer (PCT) and PCT_{i,j} is a preference or priority of transferring credits from station i to j which is a function of various factors such as power demand, renewable energy production capacity, and so on. In one embodiment, a further operational constraint of the charging station network 140 is a local consumption constraint, which can be represented as: α(yᵢ−ΣⱼCTA_{i,j}+ΣⱼCTA_{j,j}), where a is the weighting factor that balances the importance of profit maximization and maximization of local consumption of renewable energy resources (RESs), yₗ is the amount of renewable energy generated at charging station i, ΣⱼCTA_{i,j} is the total credit transferred from charging station i to all other charging stations (j), and ΣⱼCTA_{j,i} is the total credit transferred from all other charging stations j to charging station i.

In exemplary embodiments, system operator 610 of the charging station network is configured to ensure that the exchange of renewable energy credits among charging stations of a charging station operator 604 complies with one or more objective functions and operational constraints and determines optimal operational characteristics of charging stations operated by charging station operator 604 to optimize the provided objective functions across the charging stations. In one embodiment, the system operator 610 of the charging station network is configured to perform a multi-objective constrained optimization process, such as a Pareto optimization, a scaler approach, or a contextual multi-armed bandit approach, to optimize the provided objective functions across the charging stations operated by charging station operator 604.

In one embodiment, the system operator 610 of the charging station network is configured to perform a multi-objective constrained optimization process with three primary components. The first is the decision vector, comprising decision variables such as Credit Transfer Amounts (CTA), Energy Purchased from the Grid (EPG), and Energy Sold to the Grid (ESG). The second component is the objective function, where two conflicting objectives are addressed: maximizing economic profit and minimizing gas emissions. The third component involves constraints, categorized into hard and soft constraints. Hard constraints include energy balance, transmission line limits, and regulatory compliance, while soft constraints encompass preferred credit transfer and local consumption maximization. Utilizing an optimizer, possibly a derivative-free one, this process aims to determine the optimal values of decision variables.

In another embodiment, the system operator 610 of the charging station network is configured to perform a pareto optimization process that includes two steps. The first step, the optimization process, which involves solving the problem with adherence to two sets of constraints: hard constraints and soft cost constraints. This resolution employs a multi-objective optimizer, such as Multi-Objective Particle Swarm Optimization or the Non-dominated Sorting Genetic Algorithm (NSGA-II). This stage results in multiple trade-off solutions, addressing the initial conflicting objectives: F1X, aimed at maximizing economic profit, and F2X, focused on minimizing emission gases. The second step, the decision process, involves applying a preference or weighting scheme, which may be either automatically or manually selected. Ultimately, this step culminates in the establishment of a Pareto Front. This front represents a compromise solution, tailored to various criteria set by the system operator, effectively balancing the conflicting objectives.

In another embodiment, the system operator 610 of the charging station network is configured to perform a scalar approach which transforms a multi-objective optimization problem into a single objective optimization. The objective function, ƒ(X)=ω₁·ƒ₁(X)−ω₂·ƒ₂(X)−P_{sc}, is maximized, where X={CTA, EPG, ESG}^{T} is the decision variable vector, CTA is the Credit Transfer Amounts, EPG is the Energy Purchased from the Grid, ESG is the Energy Sold to the Grid, ƒ₁(X) is the Economic Profit to be maximized, ƒ₂(X) is the Carbon Emission to be minimized, P_{sc} is penalty added to the overall objective function to simulate the soft constraints, and ωᵢ are called weights and, without loss of generality, normalized such that Σωᵢ=1.

In another embodiment, the system operator 610 of the charging station network is configured to perform a multi-criteria constructed optimization strategy to determine optimal values of decision variables such as created transfer amount, energy purchased from the great, energy sold to the grid, operational cost, emission volume production, and preferred credit transfer, that maximizes joint utility function subject to this heart to the hard and soft constraints or the best trade-off Pareto solution and allows the customers to choose manually or automatically based on predefined weighting scheme or preference information set by the customers.

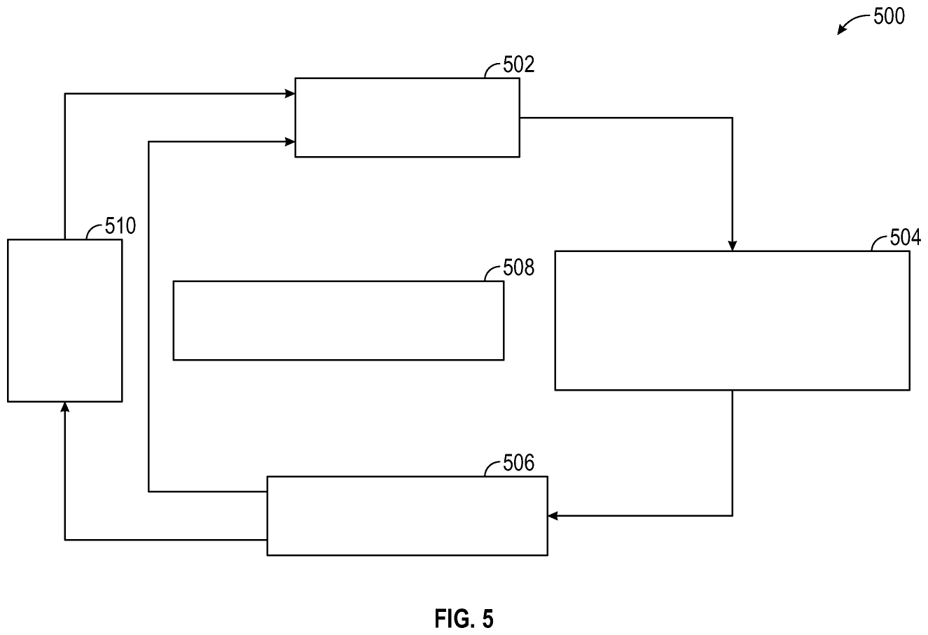

In the diagram 500, as shown in FIG. 5, a contextual multi-armed bandit agent 502 is configured to determine optimal operational characteristics of charging stations 506 operated by a charging station operator. In general, a contextual multi-armed bandit method is a decision-making strategy that decides the optimal values of decision variables. The contextual multi-armed bandit models a situation where, in a sequence of independent trials, the rendering engine automatically chooses, based on a given context 510 (side information), an action 504 from a set of possible actions to maximize a reward function 508. In exemplary embodiments, a shared context 510 is incorporated to find optimal operational characteristics of charging stations 506 in a network of charging stations based on contextual information 510 such as a vector condition, demand prediction, or charging price. These contexts 510 are used to calculate a reward 508 is associated with each arm/action 504. The Contextual multi-armed bandit agent 502 is developed by defining states/contexts 510 and possible actions 504, defining a reward function 508, training a neural network that intakes one-encoded states/context and outputs estimated rewards for each possible action, and finally depending on the learn policy, choosing action per context. Different strategies can be used to learn optimal strategies such as Epsilon-Greedy, Upper Confidence Bound (UCB), or meta-learning such as LinRel or LinUCB.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. An electric vehicle charging station comprising:
a bi-directional charger electrically coupled to an electric grid and to one or more renewable energy sources;
an energy storage device electrically connected to the bi-directional charger; and
a processing system configured to control an operation of the bi-directional charger, wherein the processing system is configured to:
monitor a state-of-charge of the energy storage device;
calculate an estimated power demand on the electric vehicle charging station for a time period based on an analysis of historical power consumption data of the electric vehicle charging station wherein the historical power consumption data includes timestamps, power consumption values, and contextual information;
calculate an estimated power generation of the one or more renewable energy sources during the time period based on historical power generation data, corresponding historical weather conditions, and a weather forecast for the time period;
based on a determination that the estimated power generation of the one or more renewable energy sources during the time period is greater than the estimated power demand during the time period and that the state-of-charge of the energy storage device is less than a maximum state-of-charge, instruct the bi-directional charger to charge the energy storage device;
based on a determination that the estimated power generation of the one or more renewable energy sources during the time period is greater than the estimated power demand during the time period and that the state-of-charge of the energy storage device is equal to the maximum state-of-charge, instruct the bi-directional charger to transmit power generated by the one or more renewable energy sources to the electric grid; and
update a renewable energy credit balance based on an amount of power generated by the one or more renewable energy sources that is transmitted to the electric grid.

2. (canceled)

3. The electric vehicle charging station of claim 1, wherein the processing system is further configured to instruct the bi-directional charger to discharge the energy storage device to meet the estimated power demand, based on a determination that the estimated power generation of the one or more renewable energy sources during the time period is less than the estimated power demand during the time period and that the state-of-charge of the energy storage device is greater than a minimum state-of-charge.

4. The electric vehicle charging station of claim 1, wherein the processing system is further configured to instruct the bi-directional charger to obtain power from the electric grid to meet the estimated power demand, based on a determination that the estimated power generation of the one or more renewable energy sources during the time period is less than the estimated power demand during the time period and that the state-of-charge of the energy storage device is equal to a minimum state-of-charge.

5. The electric vehicle charging station of claim 4, wherein the processing system is further configured to update a renewable energy credit balance based on an amount of power obtained from the electric grid.

6. The electric vehicle charging station of claim 1, wherein the processing system is further configured to monitor and record a percentage of power provided by the electric vehicle charging station to one or more vehicles during the time period that was obtained from the one or more renewable energy sources.

7. (canceled)

8. (canceled)

9. The electric vehicle charging station of claim 1, wherein the electric vehicle charging station is a first electric vehicle charging station of a plurality of electric vehicle charging stations in a charging station network.

10. An electric vehicle charging network comprising:
a charging station network management system; and
a plurality of electric vehicle charging stations in communication with the charging station network management system, wherein each of the plurality of electric vehicle charging stations include:
a bi-directional charger electrically coupled to an electric grid and to one or more renewable energy sources;
an energy storage device electrically connected to the bi-directional charger; and
a processing system configured to control an operation of the bi-directional charger, wherein the processing system is configured to:
monitor a state-of-charge of the energy storage device;
calculate an estimated power demand on the electric vehicle charging station for a time period based on an analysis of historical power consumption data of the electric vehicle charging station wherein the historical power consumption data includes timestamps, power consumption values, and contextual information;
calculate an estimated power generation of the one or more renewable energy sources during the time period based on historical power generation data, corresponding historical weather conditions, and a weather forecast;
based on a determination that the estimated power generation of the one or more renewable energy sources during the time period is greater than the estimated power demand during the time period and that the state-of-charge of the energy storage device is less than a maximum state-of-charge, instruct the bi-directional charger to charge the energy storage device;
based on a determination that the estimated power generation of the one or more renewable energy sources during the time period is greater than the estimated power demand during the time period and that the state-of-charge of the energy storage device is equal to the maximum state-of-charge, instruct the bi-directional charger to transmit power generated by the one or more renewable energy sources to the electric grid;
update a renewable energy credit balance based on an amount of power generated by the one or more renewable energy sources that is transmitted to the electric grid;
coordinate energy flow across the plurality of electric vehicle charging stations based on shared contextual data, including power generation predictions and power demand predictions; and
optimize operational characteristics of the plurality of electric vehicle charging stations using contextual multi-armed bandit analysis.

11. The electric vehicle charging network of claim 10, wherein the processing system is further configured to transmit a renewable energy credit to the charging station network management system, wherein a value of the renewable energy credit is based on an amount of power generated by the one or more renewable energy sources to the electric grid that is transmitted to the electric grid.

12. The electric vehicle charging network of claim 10, wherein the processing system is further configured to instruct the bi-directional charger to discharge the energy storage device to meet the estimated power demand, based on a determination that the estimated power generation of the one or more renewable energy sources during the time period is less than the estimated power demand during the time period and that the state-of-charge of the energy storage device is greater than a minimum state-of-charge.

13. The electric vehicle charging network of claim 10, wherein the processing system is further configured to instruct the bi-directional charger to obtain power from the electric grid to meet the estimated power demand, based on a determination that the estimated power generation of the one or more renewable energy sources during the time period is less than the estimated power demand during the time period and that the state-of-charge of the energy storage device is equal to a minimum state-of-charge.

14. The electric vehicle charging network of claim 13, wherein the processing system is further configured to obtain a renewable energy credit from the charging station network management system, wherein a value of the renewable energy credit is based on an amount of power obtained from the electric grid.

15. The electric vehicle charging network of claim 10, wherein the processing system of an electric vehicle charging station is further configured to monitor and record a percentage of power provided by the electric vehicle charging station to one or more vehicles during the time period that was obtained from the one or more renewable energy sources.

16. The electric vehicle charging network of claim 15, wherein the charging station network management system is configured to monitor and record a percentage of power provided by the plurality of electric vehicle charging stations to one or more vehicles during the time period that was obtained from the one or more renewable energy sources.

17. (canceled)

18. (canceled)

19. The electric vehicle charging network of claim 10, wherein the charging station network management system is configured to control one or more operational characteristics of the plurality of electric vehicle charging stations based on a contextual multi-armed bandit analysis of shared contextual data for the plurality of electric vehicle charging stations, wherein the shared contextual data includes power generation predictions and power demand predictions.

20. A method for operating a charging station, the method comprising:
monitoring a state-of-charge of an energy storage device of the charging station;
calculating an estimated power demand on the charging station for a time period based on an analysis of historical power consumption data of the electric vehicle charging station wherein the historical power consumption data includes timestamps, power consumption values, and contextual information;
calculating an estimated power generation of one or more renewable energy sources during the time period based on historical power generation data, corresponding historical weather conditions, and a weather forecast;
based on a determination that the estimated power generation of the one or more renewable energy sources during the time period is greater than the estimated power demand during the time period and that the state-of-charge of the energy storage device is less than a maximum state-of-charge, charging the energy storage device with power generated by the one or more renewable energy sources;
based on a determination that the estimated power generation of the one or more renewable energy sources during the time period is greater than the estimated power demand during the time period and that the state-of-charge of the energy storage device is equal to the maximum state-of-charge, transmitting power generated by the one or more renewable energy sources to an electric grid;
based on a determination that the estimated power generation of the one or more renewable energy sources during the time period is less than the estimated power demand during the time period and that the state-of-charge of the energy storage device is equal to a minimum state-of-charge, obtaining power from the electric grid to meet the estimated power demand; and
updating a renewable energy credit balance based on an amount of power generated by the one or more renewable energy sources that is transmitted to the electric grid.

21. The electric vehicle charging station of claim 1, wherein the processing system is further configured to calculate the estimated power demand on the electric vehicle charging station using machine learning models, including Autoregressive Integrated Moving Average (ARIMA), Long Short-Term Memory (LSTM) neural networks, or Gradient Boosted Trees, trained on historical power consumption data.

22. The electric vehicle charging station of claim 1, wherein the processing system is further configured to optimize the allocation of renewable energy credits using contextual multi-armed bandit analysis based on shared contextual data, including power generation predictions and power demand predictions.

23. The electric vehicle charging station of claim 1, wherein the processing system is further configured to prioritize charging the energy storage device or transmitting power to the electric grid based on an analysis of renewable energy credit values during peak and off-peak grid demand periods.

24. The electric vehicle charging station of claim 1, wherein the processing system is further configured to dynamically adjust the estimated power demand and power generation calculations based on real-time updates to weather forecasts and grid demand data.

25. The electric vehicle charging station of claim 1, wherein the processing system is further configured to calculate the environmental impact of the power transmitted to the electric grid by associating the renewable energy credits with carbon emission reduction metrics.
